(19) United States
(12) Patent Application Publication
(10) Pub. No.: US 2023/0122363 A1
(43) Pub. Date: Apr. 20, 2023

(54) STORAGE ALLOCATION BASED ON APPLICATION PRIORITY SPECIFIC TO A SELECT ENTITY

(71) Applicant: KYNDRYL, INC., New York, NY (US)

(72) Inventors: Renato Lopes Ramos, Bauru (BR); Paulo Tomiyoshi Takeda, Campinas (BR); Nathan Rodrigues Levy, Campinas (BR); Sergio Varga, Campinas (BR)

(21) Appl. No.: 17/505,002

(22) Filed: Oct. 19, 2021

(51) Int. Cl. G06F 9/48; G06F 9/50

(52) U.S. Cl. CPC G06F 9/4881; G06F 9/5016

(57) ABSTRACT

An application priority level of an application to be executed within a computing environment is determined. The application priority level is specific to a select entity. Using the application priority level of the application a storage resource of the computing environment to be allocated to one or more workloads of the select entity is selected. At least one workload of the one or more workloads includes the application. An action is taken, based on selecting the storage resource, to facilitate allocation of the storage resource.

### BACKGROUND

One or more aspects relate, in general, to processing within a computing environment, and in particular, to facilitating storage allocation within the computing environment.

Changes in information technology (IT) infrastructure occur at a high rate of speed; nevertheless, information technology administrators are to maintain availability of the infrastructure with high performance. Due to the complexity of a computing environment (multiple technologies, multiple products for the same type of technology, different infrastructures—cloud, on premises, etc.), it becomes difficult to ensure that the infrastructure is using its optimum capabilities and leveraging its maximum capabilities to fulfill requirements.

One of the areas in information technology to be managed for applications is storage since storage maintains the data and information. There are many types of storage devices, different providers, different tools to manage and different ways to connect the storage devices.

As changes occur due to replacement or upgrade of storage devices, the addition or removal of workloads, and/or an increase of data stored, a storage subject matter expert responsible for managing the devices is to be aware of the changes and to be able to properly configure, allocate and manage the storage devices.

### SUMMARY

Shortcomings of the prior art are overcome, and additional advantages are provided through the provision of a computer program product to facilitate processing within a computing environment. The computer program product includes one or more computer readable storage media and program instructions collectively stored on the one or more computer readable storage media to perform a method. The method includes determining an application priority level of an application to be executed within the computing environment. The application priority level is specific to a select entity. Using the application priority level of the application a storage resource of the computing environment to be allocated to one or more workloads of the select entity is selected. At least one workload of the one or more workloads includes the application. An action is taken, based on selecting the storage resource, to facilitate allocation of the storage resource.

Computer-implemented methods and computer systems relating to one or more aspects are also described and claimed herein. Further, services relating to one or more aspects are also described and may be claimed herein.

Additional features and advantages are realized through the techniques described herein. Other embodiments and aspects are described in detail herein and are considered a part of the claimed aspects.

### BRIEF DESCRIPTION OF THE DRAWINGS

One or more aspects are particularly pointed out and distinctly claimed as examples in the claims at the conclusion of the specification. The foregoing and objects, features, and advantages of one or more aspects are apparent from the following detailed description taken in conjunction with the accompanying drawings in which:

FIG. 1 depicts one example of architectural components used to create a storage heatmap and/or to be used to determine storage resource allocation based on application priority levels specific to an entity, in accordance with one or more aspects of the present invention;

FIG. 2 depicts one example of input data used to determine a server's priority value, in accordance with one or more aspects of the present invention;

FIG. 3 depicts one example of priority levels for select applications and servers, in accordance with one or more aspects of the present invention;

FIG. 4 depicts one example of server information for select servers, in accordance with one or more aspects of the present invention;

FIG. 5 depicts examples of heatmap index values, in accordance with one or more aspects of the present invention;

FIGS. 6A-6D depict one example of processing used to create a storage heatmap and/or to determine storage resource allocation based on application priority levels specific to an entity, in accordance with one or more aspects of the present invention;

FIG. 7 depicts one example of a computing environment to incorporate and use one or more aspects of the present invention;

FIG. 8A depicts another example of a computing environment to incorporate and use one or more aspects of the present invention;

FIG. 8B depicts further details of the memory of FIG. 8A, in accordance with one or more aspects of the present invention;

FIG. 9 depicts one embodiment of a cloud computing environment, in accordance with one or more aspects of the present invention; and

FIG. 10 depicts one example of abstraction model layers, in accordance with one or more aspects of the present invention.

### DETAILED DESCRIPTION

In one or more aspects, a capability is provided to facilitate processing within a computing environment. In one example, the capability includes identifying storage resources of a computing environment to be allocated to one or more workloads of an entity, such as a business, enterprise, service provider, customer, etc., based one or more priorities specific to the entity (e.g., provided by the entity, determined for the entity, etc.). The one or more priorities include, for instance, one or more priorities of one or more applications to be executed for the entity; one or more priorities of one or more servers used by or on behalf of the entity to, e.g., execute the applications; one or more priorities of one or more storage resources (e.g., storage devices) supporting the one or more servers; and/or a combination of application, server, and/or storage resource priorities. Other examples are also possible.

In one embodiment, a model or process is created that maps, for instance, the entity's applications, servers, server details and the corresponding storage resources, to provide a variety of information to assist machines (e.g., in machine learning), system administrators, subject matter experts (SMEs), clients, project managers, etc. to understand the utilization of the infrastructure from a utilization and priority perspective (i.e., how important or critical to the entity).

A storage heatmap is created, in one aspect, to leverage, for instance: priority information and application decomposition of an entity; server priority and connectivity information; storage information and capabilities; and/or historical storage usage information to provide insights and recommendations to, e.g., a storage administrator or storage subject matter expert about where to properly allocate new workloads or storage resources, and/or to automatically allocate the new workloads and/or storage resources, as suggested by the storage heatmap.

In one or more aspects, a number of applications and related servers are determined, and details of the storage infrastructure are considered for the model. As an example, the storage subject matter expert provides storage details, such as, for instance, tier (e.g., priority level), max input/output (I/O), max throughput (inputs are not limited and may vary), etc., as described in further detail herein.

In one or more aspects, a priority level is provided for one or more computing resources (e.g., applications, servers, storage) and the level may be one of a plurality of levels, including, for instance, low priority: less than or equal to a select value, e.g., 0.30; medium priority: from, e.g., 0.31 up to 0.80; and high priority: from, e.g., 0.81 up to 1.0. The values and/or ranges used are just examples; other values and/or ranges may be used to indicate a low, medium or high priority level. Further, in other examples, there may be additional, fewer and/or other priority levels. Other variations are possible.

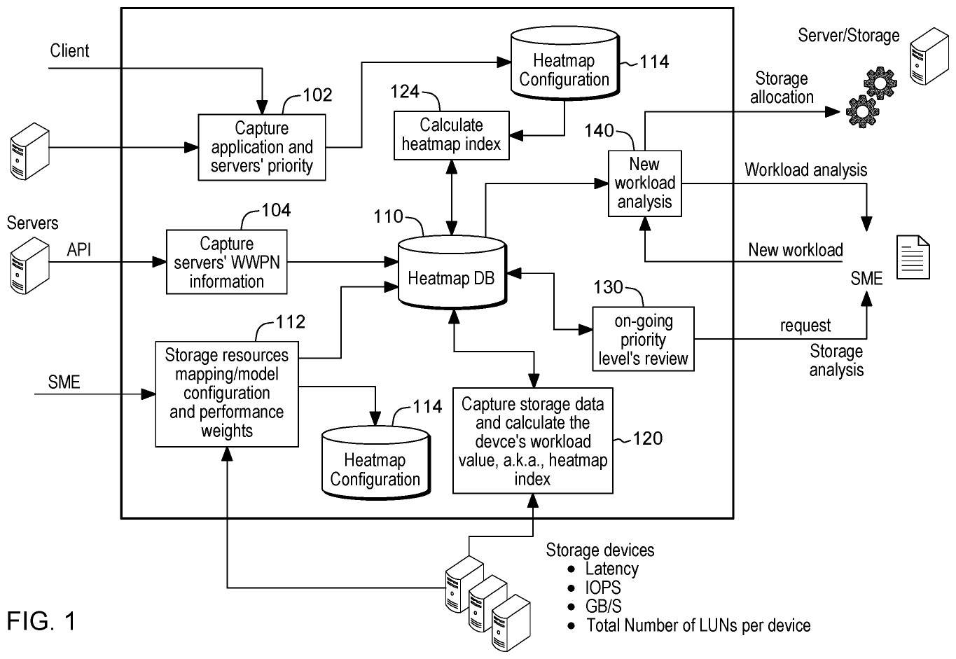

One example of an overview of architectural components used in one or more aspects of the present invention is described with reference to FIG. 1. In one example, an application/server priority capture component 102 is used to capture the priorities of one or more applications and servers. As an example, component 102 collects application information, including, for instance, application name, application description, and application priority level. The application information is collected from input provided by a client (e.g., a select entity) and/or from data stored within the computing environment, as examples. In one example, the application priority level is an indication by the select entity as to how important or critical the application is to the entity.

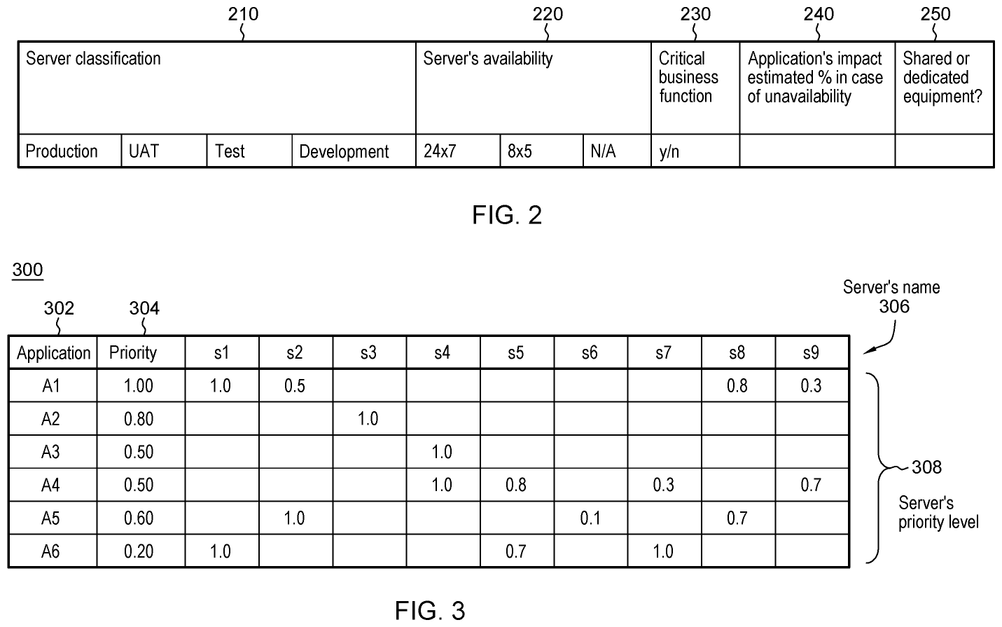

For each application identified, the following information is also collected including, for instance, the name of one or more servers that support the different components of the application and the priority level(s) of the one or more servers. Various server information may be collected, for instance, through direct access to one or more tools or repositories, or through a data input application that presents a series of questions to the client. Examples of such questions are shown in FIG. 2, and include, for instance, server classification 210 (e.g., production, test, development, user acceptance testing), server's availability 220 (e.g., 24 hours per day, eight hours a day/5 days a week, not applicable, etc.), critical business function 230 (yes, no), application's impact—estimated percentage in case of unavailability 240, and shared or dedicated equipment 250. Additional, fewer and/or other questions may be asked to collect the information. This information may also be customized according to each entity's specification, in one example.

Based on the above, a matrix is created (e.g., automatically by the process) and inserted in, for instance, a heatmap configuration database, such as heatmap configuration database 114 (FIG. 1). In one example, the heatmap configuration database is a separate database from a heatmap database (e.g., heatmap database 110) and/or it may be a part of the heatmap database. It is used to save specific configuration values from the model and provide inputs to the model in future processing, as described herein. One example of a matrix is depicted in FIG. 3. As shown, a priority matrix 300 includes, for instance, one or more applications 302 and associated priority values 304, and one or more servers 306 and associated priority values 308.

In one example, each application 302 in matrix 300 has a priority value 304 identified by, e.g., the entity, and a list of one or more servers 306 that support the application. For instance, application “A1” has the following servers to support it: S1, S2, S8 and S9. Each server's priority level is also provided in the matrix.

Returning to FIG. 1, in addition to capturing the priority values of the applications and servers, the servers' port information (e.g., World Wide Port Name (WWPN)) is captured via, e.g., a capture servers' port (e.g., WWPN) information component 104 and stored, e.g., in heatmap database 110. In one example, component 104 captures the server's World Wide Port Name host bus adapter information, which is a unique identifier for a logical unit number assigned to the server.

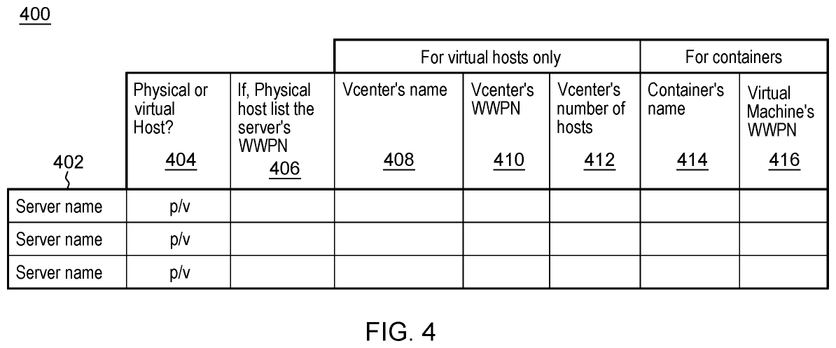

In one example, after the servers are identified and classified, as described herein, the process (e.g., component 104) collects information from the servers and saves the information in, e.g., heatmap database 110. One example of the information collected is described in FIG. 4. As an example, information 400 includes for each server 402 an indication of whether it is a physical (p) or virtual (v) host 404; the server's World Wide Port Name (or similar port identifying information) 406, if the server is a physical host; if the server is a virtual host, a virtual center's name 408, the virtual center's World Wide Port Name (or similar port identifying information) 410, and the virtual center's number of hosts 412; and if the server is a container, a container's name 414 and a virtual machine's World Wide Port Name (or similar port identifying information) 416. Additional, less and/or other information may be collected in other embodiments.

Returning to FIG. 1, additionally, in one example, a storage resources mapping/model configuration and performance weights definition component 112 collects performance data of one or more storage resources (e.g., storage devices) from the information technology infrastructure. This performance data information includes, for instance, input/output operations per second (IOPS), latency, and unit of data transfer rates (e.g., gigabytes per second), as examples.

For instance, based on the server's World Wide Port Name (or similar port identifying information) captured by, e.g., component 104, the process automatically identifies the storage devices that are supporting those logical unit numbers and updates, e.g., heatmap database 110. Further, as described below, in one example, heatmap configuration database 114 is updated.

The storage devices that were captured by the model receive their classification based on the following rules, as examples: If the storage device is hosting at least one high priority application (also referred to as a critical application), the storage device is classified as high priority; if the storage device is hosting at least one medium application and no high priority applications, the storage device is classified as medium priority; and if the storage device is hosting only low priority applications, the device is classified as low priority. Other rules and/or examples are possible.

Further, in one example, the storage subject matter expert, based on the subject matter expert's knowledge of the select entity's environment, sets proper weights for the performance data of the storage resources, including, for instance, the input/output operations per second, latency, and unit of data transfer rate. The weight is used, for instance, to make the model flexible and to support a number “N” of different performance data. For instance, a model may use one or more of the following, as examples: reads per second, writes per second, input/output operations per second, latency, unit of data transfer rates, central processor unit usage, memory usage, etc. Additional, fewer and/or other performance metrics may be used.

In one example, the weight may be used to automatically remove any performance data from the model's calculation, in which the model is then customizable to adapt to any storage infrastructure environment, which ultimately will be a reflection of the entity's environment (e.g., a customer's business environment).

Another parameter that is to be provided to the model (e.g., by the subject matter expert) is the maximum theoretical values that each storage resource (e.g., storage device) type can provide. This value is referred to as “MAX” herein. Example values include, for instance: MAXIOPS—Maximum quantity that the device can support; MAXLatency—Maximum latency that the device can provide without a performance impact; and/or MAXGBs—Maximum number of gigabytes per second that the device can provide. Additional, fewer and/or other MAX values may be used.

If additional performance data is in use, as described herein, their maximum values are also provided, in one example. This information is used, for instance, in the storage resource's workload calculation.

In one example, the total number of logical unit numbers per storage resource (e.g., storage device) is provided/updated by, e.g., the subject matter expert. This information is used, for instance, during on-going environment revalidation, described herein. For instance, the process checks if the initial priority levels are to continue as the same or if they are to be adjusted, and that comparison is performed at, e.g., the logical unit number level. Thus, the number of logical unit numbers per device is obtained to be able to compare the logical unit number workload with, e.g., the storage device workload to determine whether an adjustment is to be made.

In one example, the model is pre-configured with default values used during an on-going revalidation process, including, for instance: DowngradeCondition=70%; ReocurrenceThreshold=85%; and NumberofReocurrences=30 (days). Those values may be overwritten by, e.g., the subject matter expert. Although example conditions and values are provided, additional, fewer and/or other conditions and/or values may be used. Many variations are possible.

The DowngradeCondition is used, in one example, in future processing, in which the model validates if a specific logical unit number should remain at its priority level. When the model reaches the ReocurrenceThreshold threshold, it triggers, for instance, a notification to, e.g., the subject matter expert. The NumberofReocurrences sets a time range used by the model where it checks if the ReocurrenceThreshold is valid.

For instance, the model's default values indicate that if a specific logical unit number is under the DowngradeCondition at least 85% of the time (ReocurrenceThreshold) during the last 30 days (NumberofReocurrences), it will generate an output to, e.g., the storage subject matter expert and/or a machine, processor, etc., with the deviations captured.

In one example, parameters, such as input/output operations per second and units of data transfer rate (e.g., gigabytes per second) are aggregated values; that is, the maximum values that the device can provide by summing each individual logical unit number data.

Continuing with FIG. 1, a capture storage data and calculate the storage resource's (e.g., storage device's) workload value component 120 is used to provide a recurrent process to capture the storage data and calculate, e.g., the device's workload value, a.k.a., the heatmap index. In one example, performance data input from the storage resources (e.g., storage devices) includes, for instance: input/output operations per second (IOPS), latency, and unit of data transfer rate (e.g., gigabytes per second (GBs)). The data is collected according to the different devices in the environment, which means that this model is not restricted to one manufacturer or specific devices, and stored, for instance, in heatmap database 110.

Further, in one example, a calculate heatmap index component 124 is used to estimate the heatmap index per device, when the data is available. This includes, for instance:
Calculate each individual performance parameter % Max value, including, for instance: Max % IOPS, Max % Latency, and Max % GBs (or other Max % values for other performance parameters).

This is accomplished using the following formula, in one example:

Max %=(Current performance/Max Values)

### Example

Assume that a particular device has a MAXIOPS value of 15,000,000 and its current input/output operations per second value is 10,000,000.

Thus, its Max % IOPS would be:

Max % IOPS=10,000,000/15,000,000

Max % IOPS=0.67

This value represents that, in terms of input/output operations per second, the device is at 67% of its maximum theoretical input/output operations per second.

The same calculation is performed for each performance parameter in use by the model.

Next, heatmap index (HI), also referred to as workload value, is calculated, as follows, in one example:

$$HI = \frac{\begin{matrix}( Max \% P 1 * WeightP 1 ) + ( Max \% P 2 * WeightP 2 ) \\ + … + ( Max \% PN * WeightPN )\end{matrix}}{( WeightP 1 + WeightP 2 + … + WeightPN )}$$

For instance:

$$HI = \frac{\begin{matrix}( Max \% IOPS * WeightIOPS ) + ( Max \% Latency * \\ WeightLatency ) + ( Max \% GBs * WeightGBs )\end{matrix}}{( WeightIOPS + WeightLatency + WeightGBs )}$$

Additional, fewer and/or other performance parameters may be used.

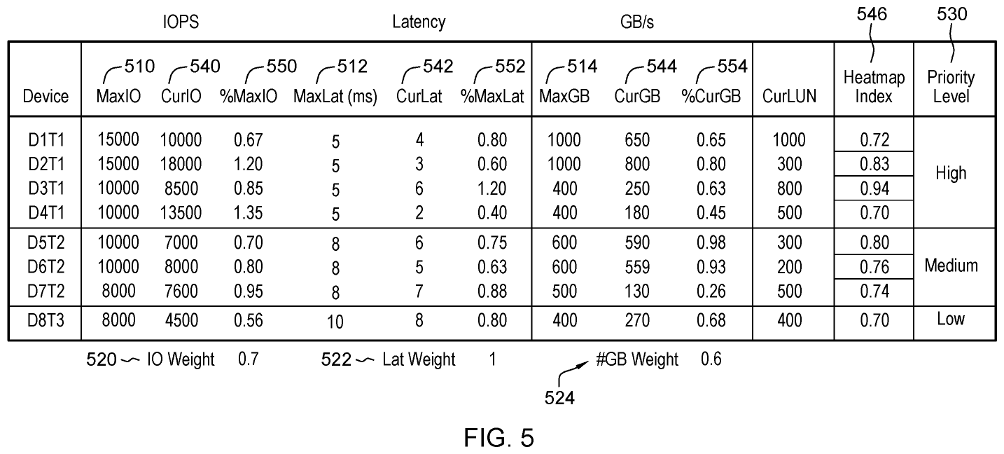

Examples of heatmap index calculations are shown in FIG. 5. Referring to FIG. 5, in one example, MaxIO (510), MaxLat (512), and MaxGB (514) are examples of the maximum theoretical levels that each device can reach/deliver. That was provided by, e.g., the storage subject matter expert based on each storage device type. The values at the bottom of the figure, such as IO Weight (520), Lat (latency) Weight (522) and #GB Weight (524) are also configured by, e.g., the subject matter expert, and those values are set in accordance with the specific entity's environment, and they may be adjusted. The column entitled Priority Level (530) is also provided in the initial model's configuration by, e.g., the subject matter expert or automatically determined based on, e.g., the corresponding applications' and/or servers' priority levels.

The columns CurIO (540), CurLat (542) and CurGB (544) are the current values captured from the storage environment. The columns % MaxIO (550), % MaxLat (552) and % CurGB (554) are the percentages determined from the corresponding current values divided by the corresponding max values (e.g., CurIO/MaxIO).

In one example, the model calculates the heatmap index 546 of each device, as described herein, and that number composed by different aspects of the storage, is used by the model in processing. The heatmap index is stored, for instance, in heatmap database 110.

One or more aspects of the model described herein provides flexibility and extensibility. For instance, the model may accept “N” numbers of performance parameters from the storage environment. It may use, for instance, reads per second, writes per second, input/output operations per second, units of data transfer rates, latency, central processing unit usage and/or memory usage, etc., as well as additional, fewer and/or other parameters.

As indicated, the overall heatmap index formula is, for example:

$$HI = \frac{\begin{matrix}( Max \% P 1 * WeightP 1 ) + ( Max \% P 2 * WeightP 2 ) \\ + … + ( Max \% PN * WeightPN )\end{matrix}}{( WeightP 1 + WeightP 2 + … + WeightPN )}$$

Assume for a particular entity the P2 parameter is not relevant; instead of eliminating the parameter or recreating the model, a weight of, e.g., zero (0) is set to the P2 parameter, providing:

$$HI = \frac{\begin{matrix}( Max \% P 1 * WeightP 1 ) + ( Max \% P 2 * WeightP 2 ) \\ + … + ( Max \% PN * WeightPN )\end{matrix}}{( WeightP 1 + WeightP 2 + … + WeightPN )}$$

$$HI = \frac{\begin{matrix}( Max \% P 1 * WeightP 1 ) + ( Max \% P 2 * 0 ) \\ + … + ( Max \% PN * WeightPN )\end{matrix}}{( WeightP 1 + 0 + … + WeightPN )}$$

$$HI = \frac{( Max \% P 1 * WeightP 1 ) + 0 ( Max \% P 1 * WeightP 1 ) + 0}{( WeightP 1 + 0 + … + WeightPN )}$$

By setting a weight of a parameter to zero, the parameter is, in a practical sense, removed from the model's calculation without the need to recreate or reconfigure the model. This allows a greater degree of expansibility and customization for the model; it is not mandatory to use input/output operations per second, latency and/or units of data transfer rate (e.g., gigabytes per second). The parameters used are related to the model's implementation rather than a constraint in the model's customization.

Returning to FIG. 1, an ongoing priority level's review component 130 is responsible for performing a new workload analysis and output recommendations to, e.g., the subject matter expert and/or machine, processor, etc., about the proper areas for allocation, in one example. It performs, for instance, a revalidation (e.g., continuously) for the environment related to the entity's priority levels that were identified during the model's creation/configuration.

The review includes, for instance, a compare of the actual data from the environment with the initial priority levels set to the applications/servers and a verification of what was considered priority continues to be priority. This analysis ensures, e.g., that the environment will be well-balanced and that non-priority areas are not allocated in the priority, usually more expensive areas, of the storage resources. This ensures that the entity has a more balanced return on investment (ROI) for the storage area, minimizes the risks and improves the availability of higher storage performance areas to entity-priority applications.

In one example, the process to revalidate the priority levels includes comparing the device's (or other storage resource's) workload with the logical unit number workload. In one example, in comparing the device, aggregated values, such as input/output operations per second and unit of data transfer rate (e.g., gigabytes per second), are taken into consideration. For instance, an additional calculation is performed, in one example, to recalculate the device's heatmap index based on an average and then comparing that result with the logical unit number heatmap index.

This includes, for instance, performing the following:

AverageIOPS=CurIOPS/total #LUNs

AverageGBs=CurGBs/total #LUNs

Then the averages are used in the formula, replacing the current performance data:

Max %=(Current performance/Max Values)

By its average:

Max % IOPS=(AverageIOPS/MaxIOPS)

Max % GBs=(AverageGBs/MaxGBs)

After that adjustment in the aggregated values, the heatmap index calculation may be performed and stored, e.g., in heatmap database 110. For example:

$$HI = \begin{matrix}( Max \% IOPS * WeightIOPS ) + ( Max \% Latency \\ \underline{* WeightLatency ) + ( Max \% GBs * WeightGBs )} \\ ( WeightIOPS + WeightLatency + WeightGBs )\end{matrix}$$

Additional, fewer and/or other performance parameters may be used.

The same heatmap index calculation is to be performed at the logical unit number level, and once the following processing is performed: average device heatmap index (adjusting the aggregated values) and the logical unit number heatmap index, both values may be compared.

One rule, which may be customized according to the entity's requirements, includes, for instance:

If the logical unit number heatmap index is below, e.g., 75% of its N−1 priority level for, e.g., 85% of the time during a pre-specified amount of time, e.g., the last 30 days, the model provides, for instance, a recommendation that that specific logical unit number is to have a downgrade on its priority level.

For instance, if that logical unit number is identified as being related to a server that is a high priority server and that logical unit number's heatmap index during the last, e.g., 30 days is below, e.g., 75% of the medium priority (high—1 level) for, e.g., 85% of the cycles, the recommendation is that that logical unit number be moved to a lower tier/priority level. On the other hand, if a medium priority level logical unit number has a heatmap index above or equal to its current priority for, e.g., 85% of the cycles during, e.g., the last 30 days, the recommendation is to adjust the logical unit number priority level to N+1, in this example to move it to a high priority area. Other examples are possible.

Further, continuing with FIG. 1, in one example, a new workload analysis component 140 is used to perform workload analysis based on new inputs. The new inputs may come from multiple sources, including, for instance, sources internal or external to the model. In one example, when the new workload input comes internally from the model, it is related to the environment that is being configured within the model, and the model already has the data that it uses to run the analytic model. An example of an internal input is a new allocation for an existing server; e.g., moving the server from one storage device to another storage device. However, when the input is external to the model, nothing is known about the new workload. Example new workloads include a new application being installed, new servers being added to the environment, etc. For external new workload analysis, the same information provided during the model's creation (e.g., using component 102) is to be provided for the new environment.

The model then uses the heatmap index information that is calculated, as described herein, and analyzes the heatmap index through the priority point of view. The overall rule is to attempt to allocate the new workload on those devices that have an overall lower utilization, and that analysis takes into consideration the entity's specificity and priorities. Thus, in one example, the model improves the return on investment of the storage environment by avoiding waste of priority areas; decreases the risks for the storage environment by avoiding allocation of a larger number of priority applications in the same storage device; and focuses on the entity's requirements as far as what is a priority for the entity.

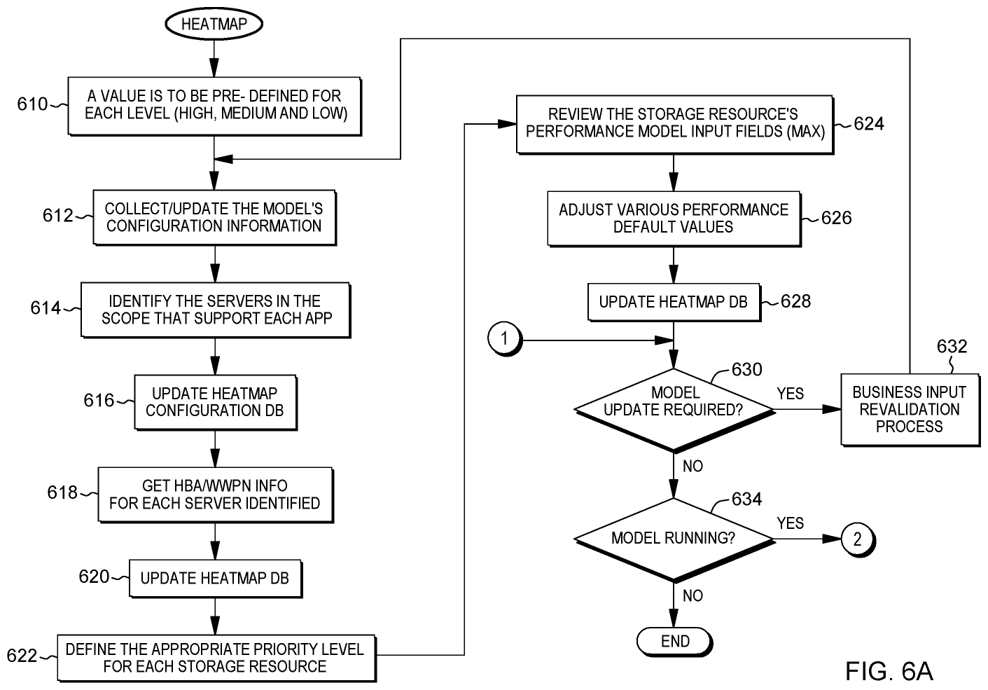

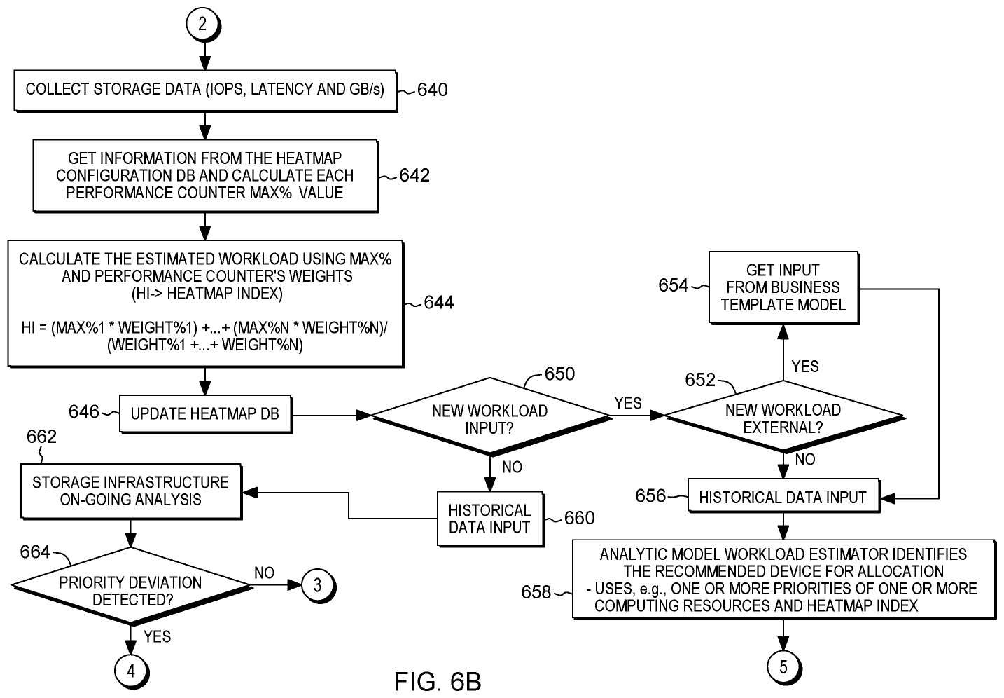

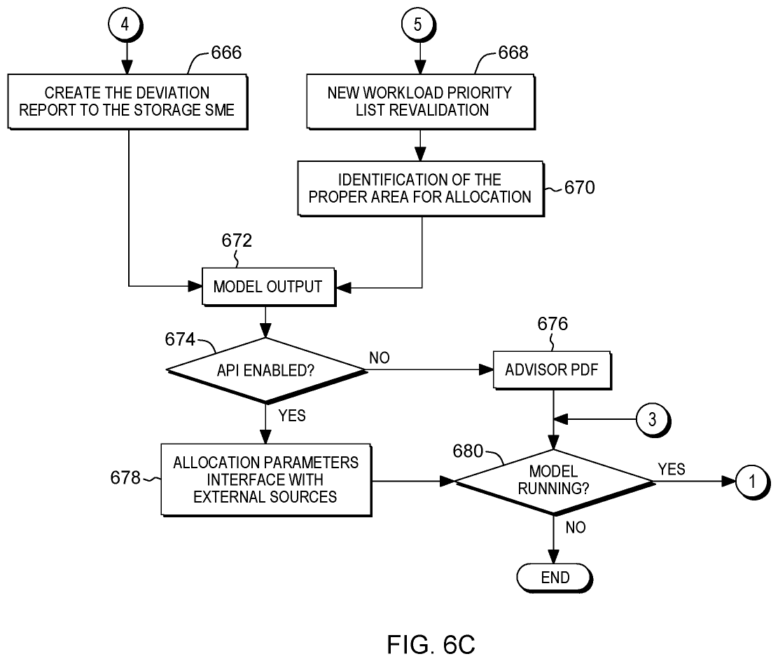

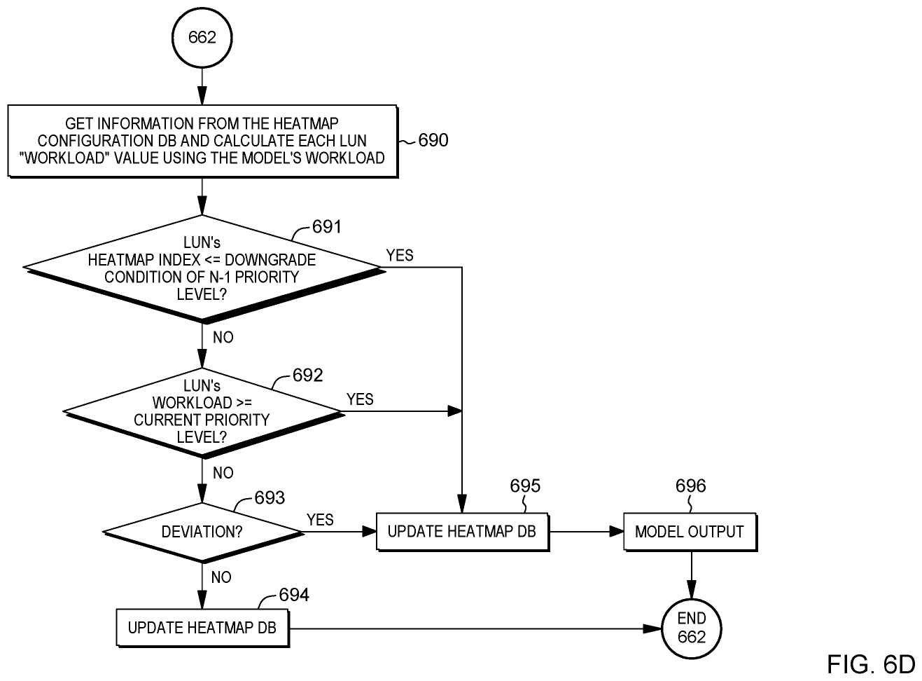

One embodiment of a process flow to provide one or more aspects of the present invention is described with reference to FIGS. 6A-6D. In one example, one or more processing circuits are used to perform the operations described with reference to the figures. The one or more processing circuits may be included in and/or implement one or more of the components depicted in FIG. 1. As one example, the components (and/or one or more processing circuits) may be included in a processor, computer system, computing unit, computing environment, etc. Many possibilities exist

Referring to FIG. 6A, in one example, initial values of the model's (or process's) heatmap index are set or updated 610. In one example, a pre-configured range from, e.g., 0.1 to 1.0 is set to identify the sub-ranges for the following example priority levels: Low: less than or equal to 0.30; Medium: from 0.31 up to 0.80; and High from 0.81 up to 1. Additional, fewer and/or other priority levels may be used. Further, other ranges and/or values may be used and/or other ranges and/or values for a priority level may be used. The ranges/values provided herein are just examples. Many examples are possible.

Additionally, the initial model's configuration information is collected 612. For instance, answers to a pre-defined set of questions provide the initial configuration to the model, as well as determine the priority level for each identified server supported by the model. The initial input provided by, e.g., the select entity (e.g., business customer) identifies the applications that are to be covered. As an example, the initial input includes, for instance, application name, application description, and application priority level. For each application identified, the server's name that supports the different components of the application is also provided as input. The server's priority level is determined, for instance, based on the one or more applications it supports.

In one example, the servers that support (run) each application are identified 614. For instance, for each application, the servers that support that specific application are listed.

The heatmap configuration database (e.g., heatmap configuration database 114) is updated 616. In one example, the heatmap configuration database is a separate database from the heatmap database (e.g., heatmap database 110). It is used to save specific configuration values from the model and provide inputs to the model in future processing.

The host bus adapter/World Wide Port Name (or other port identifier) for each server listed (in, e.g., operation 614) is obtained 618. This information is used in the model for identification and analysis of the heatmap index. Based on the collected information, the heatmap database is updated 620. In one example, the collected/calculated information is used to identify the heatmap index and is used as input to the predictive model for analysis.

Additionally, in one example, an appropriate priority level (or tier) for each storage resource is defined 622. For instance, the storage environment that is part of this model is mapped by, e.g., the storage team using the same approach (e.g., low, medium and high) according to the tiers/device capabilities (performance) and using the same pre-defined range (0.1˜1.0), as examples.

The storage resource's performance model input fields (e.g., Max values) are reviewed 624. For instance, the model collects and uses basic performance indicators to calculate an overall current heatmap index of, e.g., a storage device. These indicators include, for instance, input/output operations per second, latency and units of data transfer rate (e.g., gigabytes per second). Additional, fewer and/or other indicators, metrics or parameters may be used.

Further, a maximum value for each of the parameters is defined (e.g., by the storage team) based on the tiers/devices' capabilities collected in 622. Although certain performance indicators are provided, the model is flexible and may accept additional, fewer and/or other performance inputs to calculate the estimated heatmap index.

In one example, various performance default values are adjusted 626. As described herein, in one example, the heatmap model is pre-configured with the following default values, as examples: DowngradeCondition=70%, ReocurrenceThreshold=85%, and NumberofReocurrences=30 (days). Other percentages, values and/or time periods may be used. Further, the values may be adjusted according to the specificity of each entity's environment, which adds another level of flexibility to the present model.

Further, the heatmap database is updated 628. For instance, previous configuration processing is saved/updated.

A determination is made as to whether an update of the model is to be performed 630. This is a control point for when, e.g., the model is running. As the model captures on-going storage data (e.g., continuously), it has the capability to identify changes in the environment's behavior. Thus, the model can raise, for instance, a revalidation process to adjust, for instance, priority levels of one or more computing resources (e.g., storage resources (e.g., storage devices), servers, applications, etc.).

Should it be determined that a model update is to be performed, an input revalidation process is initiated 632. For instance, this may be triggered based on the model identifying differences from the defined application priority and its actual behavior. Processing continues at 612.

Returning to inquiry 630, if a model update is not to be performed, a determination is made as to whether the model is running 634. If the model is not running, processing is complete. However, if it is verified that the model is running, processing continues at operation 640 in FIG. 6B.

For instance, storage data (e.g., input/output operations per second, latency, and units of data transfer rate (e.g., gigabytes per second)) is collected 640. The data collection may be configured in different ways, including, for example, exporting the devices' data as comma separated values for an import batch process later and/or on-line data gathering. The data collection process selected depends, e.g., on the entity's environment/policies, as an example.

In one example, the process obtains information from the heatmap configuration database to calculate each performance counter max percentage value 642. For instance, the inputs for maximum values (624) and data captured from the environment (640) are used to calculate the temporary value of the Max %, which indicates the current percentage of that parameter as it relates to the theoretical maximum allowed. For example, assume Max Latency for a particular device type is 5 ms, Current Latency for that particular device type is 4 ms, and Max % Latency=current/maximum, Max % Latency=4/5=80%. This value means, in this example, that this particular device is at 80% of its theoretical maximum latency allowed. The values used in the examples provided herein are only examples; other values may be used without departing from the spirit of one or more aspects of the invention.

The estimated workload is calculated 644 through a weighted average from the Max % values (642), and each respective weight that was previously defined (e.g., 112 of FIG. 1). For instance, Heatmap Index=(Max % 1*weight % 1)++(Max % N*weight % N)/weight % 1++weight % N). The weight value and/or range may be any selected value and/or range defined by, e.g., the select entity depending, for instance, on which metric or parameter is more important to the select entity.

Continuing with FIG. 6B, heatmap database is updated 646 with, e.g., the captured and calculated information.

In one example, a determination is made as to whether there is a new workload input 650. The model may obtain inputs for new workloads from different sources, including, for instance, on-going activity, new project activity, and/or new storage allocations. Should there be a new workload input, a determination is made as to whether the input is a new workload external input 652. This verification identifies whether the new workload is from an external model's source, or from the current model.

If there is a new workload from an external model's source, then, in one example, the model collects the business application information 654, as defined in, e.g., 612. Processing continues with historical data input 656. For instance, the model employs the historical data collected and stored from, e.g., operations 640, 642 and 644 that may be used to predict the final status once the new workload is loaded.

Further, in one example, an analytic model workload estimator identifies the recommended device for allocation 658. For instance, the model analyzes the heatmap index created and compares it with the entity's application/servers' priority levels to create the input to operation 670 (described below). For instance, in one example, a server of one or more servers capable of executing an application is selected based on priorities of the application and the one or more servers. As an example, if an application has a high priority, then if available, a high priority server is selected. Further, a high priority storage device is allocated to the high priority server. If there are multiple storage devices with a high priority, then the heatmap indices are used to select the storage device to be allocated. For instance, the storage device with least utilization and high priority is used for a high priority application.

As described herein, the priority level of an application is used in selecting a storage resource to be allocated to the server executing the application. In one example, if the server and application have different priority levels, the priority of the application is controlling. For instance, if, e.g., only a high priority server is available to execute a medium or low priority application, a medium or low priority storage device is allocated rather than a high priority storage device. Other examples are possible.

Further, referring to FIG. 6C, a new workload priority list is revalidated 668. For instance, the model compares/adjusts the new predicted results with the priority list obtained from the new workload input. Additionally, in one example, a proper area for allocation is identified 670. By comparing the results from, e.g., operations 658 and 668 with the environment priority configuration, the model defines where each new workload allocation is to be created. Processing then continues to output the model 672, described below.

Returning to inquiry 652 (FIG. 6B), should the new workload be internal, processing continues at 656 in which data collected and stored using operations 640-644 is used to predict the final status.

Further, in one example, referring to inquiry 650, should there be no new workload input, processing continues to historical data input 660. For instance, the model employs the historical data collected and stored from operations 640, 642 and 644, which is used to predict the final status.

In one embodiment, the model runs an on-going basis analysis of the current environment comparing the initial entity input received (e.g., 610-616) with the current performance data captured 662. This is described further with reference to FIG. 6D. For instance, information is obtained from the heatmap configuration database, and each logical unit number's workload value is calculated using the model's workload 690. As an example, the data captured as an on-going basis by the model is used, as well as the same parameters and model's workload calculation process. Information is read from the heatmap configuration database, including, for instance, DowngradeCondition, ReocurrenceThreshold and NumberofReocurrences.

A determination is made as to whether the logical unit number's workload value (e.g., heatmap index) is equal to or less than, e.g., DowngradeCondition of the N−1 priority level 691. As an example, if the priority of the logical unit number is high (tier1), then the N−1 priority level is medium (Tier2). If the logical unit number's workload value is not equal to or less than DowngradeCondition of the N−1 priority level, then a further determination is made as to whether the logical unit number's workload value is greater than or equal to its current workload priority level defined for its device type 692. If the logical unit number's workload value is not greater than or equal to the current priority level, then a check is made as to whether the deviation is above its priority level for a reoccurrence based on the ReocurrenceThreshold and NumberofReocurrences parameters values 693. For a priority deviation to be valid it is to be, e.g., equal to or less than the ReocurrenceThreshold for the last NumberofReocurrences (measured in, e.g., days). If the deviation is not above the priority level, the heatmap database is updated with the information related to deviations, if applicable 694, and this on-going analysis processing is complete.

Returning to inquiry 691, if the logical unit number's heatmap index is less than or equal to the downgrade condition of N−1 priority level or if the logical unit number's workload value is greater than or equal to the current priority level 692 or if the deviation is greater than its priority level for a reoccurrence, the heatmap database is updated with the information related to deviations, if applicable 695. Further, in one example, the model compiles and provides the output according to the options defined 696. Processing of the on-going analysis is complete.

Returning to FIG. 6B, based on the analysis, a determination is made as to whether a priority deviation has been detected 664. For instance, does the model identify differences between what the entity provided and what the model is observing from the actual environment (e.g., application performance that does not match the actual values; priority of one or more computing resources is different than expected, etc.)? If there exists a deviation between what was provided by the entity and what is being collected from the environment, in one example, referring to FIG. 6C, the model generates and sends a report to, e.g., the storage subject matter expert (and/or a machine, processor, etc.) 666. This includes, for instance, the application name and priority, servers where the deviation was identified showing current priority level and the model's recommended priority level, and logical unit numbers that may be changed according to the model's recommendation. The report may include additional, less and/or other information.

The model compiles and provides the output according to the options defined 672. Further, a determination is made as to whether a selected application programming interface, e.g., a RESTFul application programming interface, is enabled from a third party solution, such as Openstack or others 674. This model can provide the information for the allocation to be performed automatically.

If a selected application programming interface is not to be used, the model can be used as an advisor and provides the results in, e.g., a portable document format (PDF) format to, e.g., the storage team indicating a behavior's deviation (allocations that are to be reviewed) and new allocation recommendations, as examples 676. Processing continues with inquiry 680, described below.

However, if a selected application programming interface is enabled 674, a specific model may be created to provide the interface with, e.g., the third-party software 678. Processing continues at INQUIRY 680 in which a determination is made as to whether the model is running as, e.g., a recurrent process 680. If not, processing is complete. Otherwise, processing continues to INQUIRY 630 (FIG. 6A).

Returning to INQUIRY 664 (FIG. 6B), if a priority deviation is not detected, in one example, processing continues to 680 in FIG. 6C.

As described herein, in one or more aspects, a model or process is provided to facilitate allocation of computing resources, such as storage resources (e.g., storage devices) in a computing environment based on priorities of an entity (e.g., a business). One or more aspects assist, e.g., a storage subject matter expert and/or an automatic process, in properly and efficiently allocating and managing the storage infrastructure with an objective to optimize the storage infrastructure among, e.g., all (or select) clients and applications. With the obtained, determined and/or analyzed information, the storage subject matter expert and/or automatic process may better allocate storage for a specific application leveraging the current infrastructure and application's requirements. Appropriate decisions may be made when there is, e.g., a change or provision of the storage infrastructure, based on an entity's priorities, as well as a provision of a better return on investment over the storage infrastructure, consequently, minimizing the risks to applications due to an improper use of the storage subsystem.

One or more aspects ensure that the best (i.e., most appropriate) storage resources are used for new demands based upon leveraging, e.g., application priority levels; provide guidance to application owners and/or infrastructure teams to move application(s) to most appropriate storage systems as well as storage tier (this recommendation focuses on maximizing the return on investment); provide a comprehensive view of the infrastructure based, e.g., on application priority level versus storage, versus storage tier. This view shows performance statistics of storage systems and provides a complete end-to-end mapping or system inventory; provide a complete view of the information technology infrastructure that connects applications to infrastructure and for each component there is a level of priority defined by, e.g., the entity; and/or provide an automatic analytic capability process that may be used as a source of information for, e.g., storage administrators or storage subject matter experts, as examples, to manage the storage infrastructure based on one or more of efficiency, priority level, storage tiering, number of applications, number of servers, etc.

One or more aspects may be integrated in a storage configuration tool (which may be vendor indifferent); be a product on its own; and/or be leveraged as a service. One or more aspects provide a proactive approach to provide a response (e.g., indication of and/or allocation of storage resources), based on a request by, e.g., a customer.

One or more aspects of the present invention are inextricably tied to computer technology and facilitate processing within a computer, improving performance thereof. The use of a process to automatically determine allocation/re-allocation of storage resources based, for instance, on one or more priority levels of an entity, and/or to automatically allocate/re-allocate resources reduces complexity within a computing environment and improves processing. In one or more aspects, storage resource allocation is improved, as well as workload balancing.

Although embodiments are described herein, other variations and embodiments are possible.

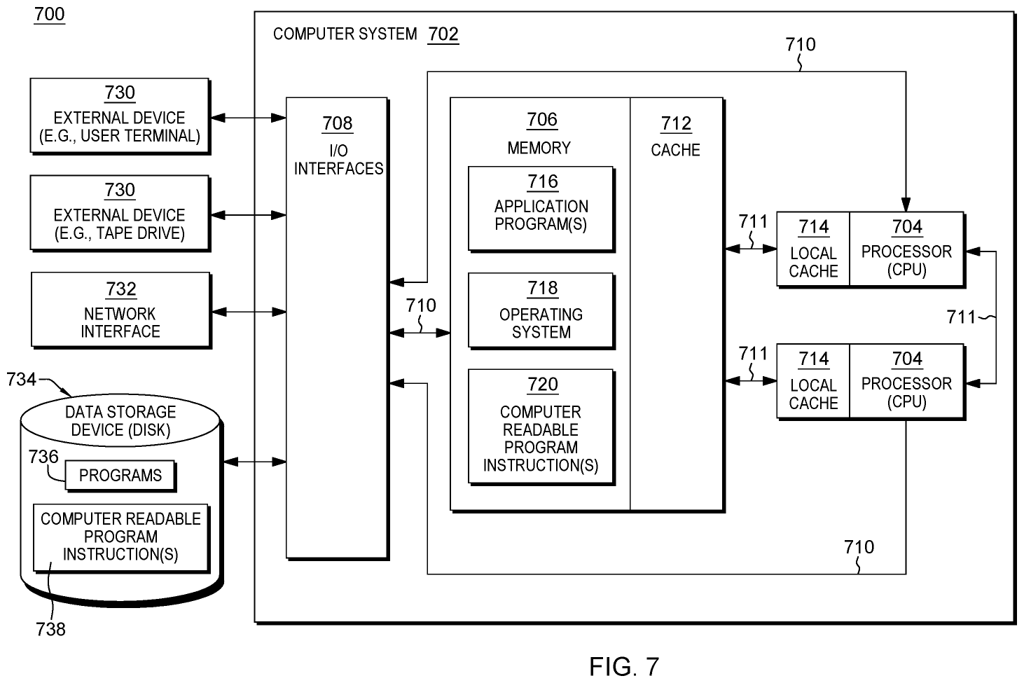

One or more aspects of the present invention may be incorporated and/or used in many computing environments. One embodiment of a computing environment to incorporate and use one or more aspects of the present invention is described with reference to FIG. 7. As shown in FIG. 7, a computing environment 700 includes, for instance, a computer system 702 shown, e.g., in the form of a general-purpose computing device. Computer system 702 may include, but is not limited to, one or more processors or processing units 704 (e.g., central processing units (CPUs) and/or special-purpose processors, etc.), a memory 706 (a.k.a., system memory, main memory, main storage, central storage or storage, as examples), and one or more input/output (I/O) interfaces 708, coupled to one another via one or more buses and/or other connections. For instance, processors 704 and memory 706 are coupled to I/O interfaces 708 via one or more buses 710, and processors 704 are coupled to one another via one or more buses 711.

Bus 711 is, for instance, a memory or cache coherence bus, and bus 710 represents one or more of any of several types of bus structures, including a memory bus or memory controller, a peripheral bus, an accelerated graphics port, and a processor or local bus using any of a variety of bus architectures. By way of example, and not limitation, such architectures include the Industry Standard Architecture (ISA), the Micro Channel Architecture (MCA), the Enhanced ISA (EISA), the Video Electronics Standards Association (VESA) local bus, and the Peripheral Component Interconnect (PCI).

Memory 706 may include, for instance, a cache 712, such as a shared cache, which may be coupled to local caches 714 of processors 704 via, e.g., one or more buses 711. Further, memory 706 may include one or more programs or applications 716, at least one operating system 718, and one or more computer readable program instructions 720. Computer readable program instructions 720 may be configured to carry out functions of embodiments of aspects of the invention.

Computer system 702 may communicate via, e.g., I/O interfaces 708 with one or more external devices 730, such as a user terminal, a tape drive, a pointing device, a display, and one or more data storage devices 734, etc. A data storage device 734 may store one or more programs 736, one or more computer readable program instructions 738, and/or data, etc. The computer readable program instructions may be configured to carry out functions of embodiments of aspects of the invention.

Computer system 702 may also communicate via, e.g., I/O interfaces 708 with network interface 732, which enables computer system 702 to communicate with one or more networks, such as a local area network (LAN), a general wide area network (WAN), and/or a public network (e.g., the Internet), providing communication with other computing devices or systems.

Computer system 702 may include and/or be coupled to removable/non-removable, volatile/non-volatile computer system storage media. For example, it may include and/or be coupled to a non-removable, non-volatile magnetic media (typically called a “hard drive”), a magnetic disk drive for reading from and writing to a removable, non-volatile magnetic disk (e.g., a “floppy disk”), and/or an optical disk drive for reading from or writing to a removable, non-volatile optical disk, such as a CD-ROM, DVD-ROM or other optical media. It should be understood that other hardware and/or software components could be used in conjunction with computer system 702. Examples, include, but are not limited to: microcode, device drivers, redundant processing units, external disk drive arrays, RAID systems, tape drives, and data archival storage systems, etc.

Computer system 702 may be operational with numerous other general-purpose or special purpose computing system environments or configurations. Examples of well-known computing systems, environments, and/or configurations that may be suitable for use with computer system 702 include, but are not limited to, personal computer (PC) systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

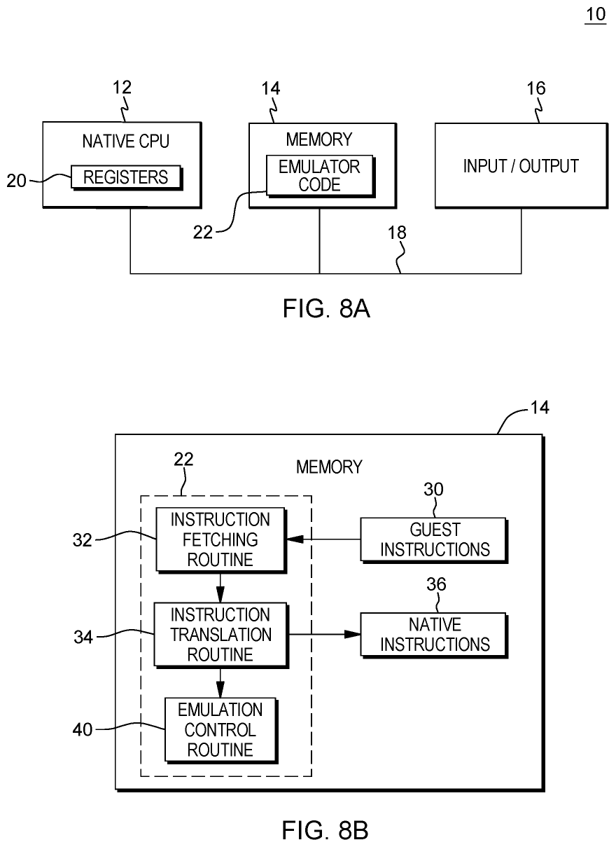

Another embodiment of a computing environment to incorporate and use one or more aspects of the present invention is described with reference to FIG. 8A. In this example, a computing environment 10 includes, for instance, a native central processing unit (CPU) 12, a memory 14, and one or more input/output devices and/or interfaces 16 coupled to one another via, for example, one or more buses 18 and/or other connections. As examples, computing environment 10 may include an IBM® Power® processor offered by International Business Machines Corporation, Armonk, N.Y.; an HP Superdome with Intel® processors offered by Hewlett Packard Co., Palo Alto, Calif.; and/or other machines based on architectures offered by International Business Machines Corporation, Hewlett Packard, Intel Corporation, Oracle, or others. IBM and Power are trademarks or registered trademarks of International Business Machines Corporation in at least one jurisdiction. Intel is a trademark or registered trademark of Intel Corporation or its subsidiaries in the United States and other countries.

Native central processing unit 12 includes one or more native registers 20, such as one or more general purpose registers and/or one or more special purpose registers used during processing within the environment. These registers include information that represents the state of the environment at any particular point in time.

Moreover, native central processing unit 12 executes instructions and code that are stored in memory 14. In one particular example, the central processing unit executes emulator code 22 stored in memory 14. This code enables the computing environment configured in one architecture to emulate another architecture. For instance, emulator code 22 allows machines based on architectures other than, e.g., the IBM® z/Architecture® instruction set architecture, such as Power processors, HP Superdome servers or others, to emulate the z/Architecture instruction set architecture and to execute software and instructions developed based on the z/Architecture instruction set architecture. z/Architecture is a trademark or registered trademark of International Business Machines Corporation in at least one jurisdiction.

Further details relating to emulator code 22 are described with reference to FIG. 8B. Guest instructions 30 stored in memory 14 comprise software instructions (e.g., correlating to machine instructions) that were developed to be executed in an architecture other than that of native CPU 12. For example, guest instructions 30 may have been designed to execute on a processor based on the z/Architecture instruction set architecture, but instead, are being emulated on native CPU 12, which may be, for example, an Intel processor. In one example, emulator code 22 includes an instruction fetching routine 32 to obtain one or more guest instructions 30 from memory 14, and to optionally provide local buffering for the instructions obtained. It also includes an instruction translation routine 34 to determine the type of guest instruction that has been obtained and to translate the guest instruction into one or more corresponding native instructions 36. This translation includes, for instance, identifying the function to be performed by the guest instruction and choosing the native instruction(s) to perform that function.

Further, emulator code 22 includes an emulation control routine 40 to cause the native instructions to be executed. Emulation control routine 40 may cause native CPU 12 to execute a routine of native instructions that emulate one or more previously obtained guest instructions and, at the conclusion of such execution, return control to the instruction fetch routine to emulate the obtaining of the next guest instruction or a group of guest instructions. Execution of the native instructions 36 may include loading data into a register from memory 14; storing data back to memory from a register; or performing some type of arithmetic or logic operation, as determined by the translation routine.

Each routine is, for instance, implemented in software, which is stored in memory and executed by native central processing unit 12. In other examples, one or more of the routines or operations are implemented in firmware, hardware, software or some combination thereof. The registers of the emulated processor may be emulated using registers 20 of the native CPU or by using locations in memory 14. In embodiments, guest instructions 30, native instructions 36 and emulator code 22 may reside in the same memory or may be disbursed among different memory devices.

The computing environments described above are only examples of computing environments that can be used. Other environments, including but not limited to, non-partitioned environments, partitioned environments, cloud environments and/or emulated environments, may be used; embodiments are not limited to any one environment. Although various examples of computing environments are described herein, one or more aspects of the present invention may be used with many types of environments. The computing environments provided herein are only examples.

Each computing environment is capable of being configured to include one or more aspects of the present invention. For instance, each may be configured to incorporate and/or use one or more aspects of a storage heatmap process, a storage allocation process, and/or to include and/or implement, e.g., the components of FIG. 1, in accordance with one or more aspects of the present invention.

Although various embodiments are described herein, many variations and other embodiments are possible without departing from a spirit of aspects of the present invention. It should be noted that, unless otherwise inconsistent, each aspect or feature described herein, and variants thereof, may be combinable with any other aspect or feature.

One or more aspects may relate to cloud computing.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

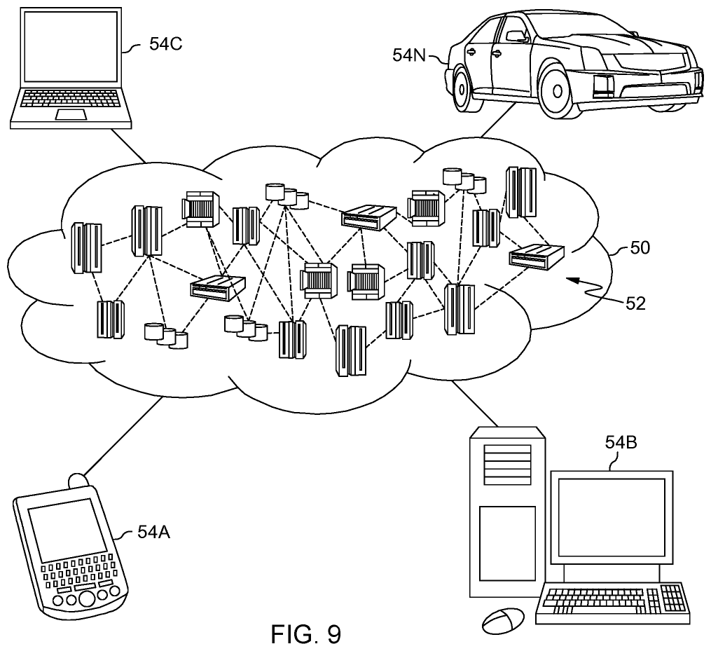

Referring now to FIG. 9, illustrative cloud computing environment 50 is depicted. As shown, cloud computing environment 50 includes one or more cloud computing nodes 52 with which local computing devices used by cloud consumers, such as, for example, personal digital assistant (PDA) or cellular telephone 54A, desktop computer 54B, laptop computer 54C, and/or automobile computer system 54N may communicate. Nodes 52 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 9 are intended to be illustrative only and that computing nodes 52 and cloud computing environment 50 can communicate with any type of computerized device over any type of network and/or network addressable connection (e.g., using a web browser).

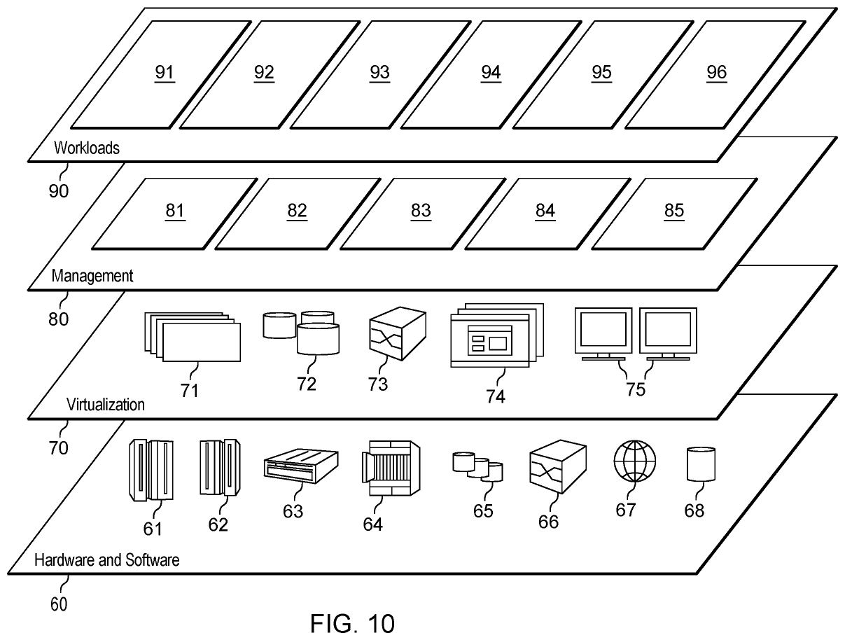

Referring now to FIG. 10, a set of functional abstraction layers provided by cloud computing environment 50 (FIG. 9) is shown. It should be understood in advance that the components, layers, and functions shown in FIG. 10 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and storage heatmap/storage resources allocation processing 96.

Aspects of the present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

In addition to the above, one or more aspects may be provided, offered, deployed, managed, serviced, etc. by a service provider who offers management of customer environments. For instance, the service provider can create, maintain, support, etc. computer code and/or a computer infrastructure that performs one or more aspects for one or more customers. In return, the service provider may receive payment from the customer under a subscription and/or fee agreement, as examples. Additionally, or alternatively, the service provider may receive payment from the sale of advertising content to one or more third parties.

In one aspect, an application may be deployed for performing one or more embodiments. As one example, the deploying of an application comprises providing computer infrastructure operable to perform one or more embodiments.

As a further aspect, a computing infrastructure may be deployed comprising integrating computer readable code into a computing system, in which the code in combination with the computing system is capable of performing one or more embodiments.

As yet a further aspect, a process for integrating computing infrastructure comprising integrating computer readable code into a computer system may be provided. The computer system comprises a computer readable medium, in which the computer medium comprises one or more embodiments. The code in combination with the computer system is capable of performing one or more embodiments.

Although various embodiments are described above, these are only examples. For example, different types of operations may be employed. Many variations are possible.

Various aspects are described herein. Further, many variations are possible without departing from a spirit of aspects of the present invention. It should be noted that, unless otherwise inconsistent, each aspect or feature described herein, and variants thereof, may be combinable with any other aspect or feature.

Further, other types of computing environments can benefit and be used. As an example, a data processing system suitable for storing and/or executing program code is usable that includes at least two processors coupled directly or indirectly to memory elements through a system bus. The memory elements include, for instance, local memory employed during actual execution of the program code, bulk storage, and cache memory which provide temporary storage of at least some program code in order to reduce the number of times code must be retrieved from bulk storage during execution.

Input/output or I/O devices (including, but not limited to, keyboards, displays, pointing devices, DASD, tape, CDs, DVDs, thumb drives and other memory media, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems, and Ethernet cards are just a few of the available types of network adapters.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components and/or groups thereof.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated.

What is claimed is:

1. A computer program product for facilitating processing within a computing environment, the computer program product comprising:
one or more computer readable storage media and program instructions collectively stored on the one or more computer readable storage media to perform a method comprising:
determining an application priority level of an application to be executed within the computing environment, the application priority level being specific to a select entity;
selecting, using the application priority level of the application, a storage resource of the computing environment to be allocated to one or more workloads of the select entity, at least one workload of the one or more workloads including the application; and
taking an action, based on selecting the storage resource, to facilitate allocation of the storage resource.

2. The computer program product of claim 1, wherein the taking the action comprises initiating allocation of the storage resource.

3. The computer program product of claim 1, wherein the method further comprises:
identifying one or more potential servers to execute the application;
determining one or more server priority levels of the one or more potential servers; and
selecting a server of the one or more potential servers to execute the application, the selecting being based on the application priority level of the application and the one or more server priority levels, and wherein the storage resource that is selected is to be allocated to the server to execute the application.

4. The computer program product of claim 1, wherein the method further comprises:
identifying a plurality of storage resources of the computing environment; and
determining one or more storage resource priority levels of the plurality of storage resources, and wherein the selecting the storage resource comprises using the application priority level of the application and the one or more storage resource priority levels to select the storage resource.

5. The computer program product of claim 4, wherein the method further comprises obtaining select performance data of at least a portion of the plurality of storage resources, the select performance data to be used to determine one or more workload performance values of the at least a portion of the plurality of storage resources, and wherein the selecting the storage resource further comprises using the one or more workload performance values to select the storage resource.

6. The computer program product of claim 5, wherein the method further comprises setting one or more weight values for the select performance data, the select performance data and the one or more weight values to be used to determine the one or more workload performance values.

7. The computer program product of claim 6, wherein the method further comprises determining the one or more workload performance values, wherein the determining a workload performance value of the one or more workload performance values comprises using a formula, the formula using at least a portion of the select performance data and at least one weight of the one or more weights.

8. The computer program product of claim 5, wherein the select performance data is selected from a group consisting of input/output processing per second, latency, and unit of data transfer rate.

9. The computer program product of claim 4, wherein the method further comprises revalidating at least one storage resource priority level of the one or more storage resource priority levels based on current processing associated with at least one storage resource of the plurality of storage resources.

10. The computer program product of claim 1, wherein the selecting comprises using one or more priority levels of one or more computing resources including the application priority level to select the storage resource, and wherein the method further comprises performing revalidation of the one or more priority levels based on processing within the computing environment.

11. A computer system for facilitating processing within a computing environment, the computer system comprising:
a memory; and
at least one processor in communication with the memory, wherein the computer system is configured to perform a method, said method comprising:
determining an application priority level of an application to be executed within the computing environment, the application priority level being specific to a select entity;
selecting, using the application priority level of the application, a storage resource of the computing environment to be allocated to one or more workloads of the select entity, at least one workload of the one or more workloads including the application; and
taking an action, based on selecting the storage resource, to facilitate allocation of the storage resource.

12. The computer system of claim 11, wherein the method further comprises:
identifying one or more potential servers to execute the application;
determining one or more server priority levels of the one or more potential servers; and
selecting a server of the one or more potential servers to execute the application, the selecting being based on the application priority level of the application and the one or more server priority levels, and wherein the storage resource that is selected is to be allocated to the server to execute the application.

13. The computer system of claim 11, wherein the method further comprises:
identifying a plurality of storage resources of the computing environment; and
determining one or more storage resource priority levels of the plurality of storage resources, and wherein the selecting the storage resource comprises using the application priority level of the application and the one or more storage resource priority levels to select the storage resource.

14. The computer system of claim 13, wherein the method further comprises:
obtaining select performance data of at least a portion of the plurality of storage resources; and
setting one or more weight values for the select performance data, the select performance data and the one or more weight values to be used to determine one or more workload performance values of the at least a portion of the plurality of storage resources, and wherein the selecting the storage resource further comprises using the one or more workload performance values to select the storage resource.

15. The computer system of claim 11, wherein the selecting comprises using one or more priority levels of one or more computing resources including the application priority level to select the storage resource, and wherein the method further comprises performing revalidation of the one or more priority levels based on processing within the computing environment.

16. A computer-implemented method of facilitating processing within a computing environment, the computer-implemented method comprising:
determining an application priority level of an application to be executed within the computing environment, the application priority level being specific to a select entity;
selecting, using the application priority level of the application, a storage resource of the computing environment to be allocated to one or more workloads of the select entity, at least one workload of the one or more workloads including the application; and
taking an action, based on selecting the storage resource, to facilitate allocation of the storage resource.

17. The computer-implemented method of claim 16, further comprising:
identifying one or more potential servers to execute the application;
determining one or more server priority levels of the one or more potential servers; and
selecting a server of the one or more potential servers to execute the application, the selecting being based on the application priority level of the application and the one or more server priority levels, and wherein the storage resource that is selected is to be allocated to the server to execute the application.

18. The computer-implemented method of claim 16, further comprising:
identifying a plurality of storage resources of the computing environment; and
determining one or more storage resource priority levels of the plurality storage resources, and wherein the selecting the storage resource comprises using the application priority level of the application and the one or more storage resource priority levels to select the storage resource.

19. The computer-implemented method of claim 18, further comprising:
obtaining select performance data of at least a portion of the plurality of storage resources; and
setting one or more weight values for the select performance data, the select performance data and the one or more weight values to be used to determine one or more workload performance values of the at least a portion of the plurality of storage resources, and wherein the selecting the storage resource further comprises using the one or more workload performance values to select the storage resource.

20. The computer-implemented method of claim 16, wherein the selecting comprises using one or more priority levels of one or more computing resources including the application priority level to select the storage resource, and further comprising performing revalidation of the one or more priority levels based on processing within the computing environment.
